(19) United States
(12) Patent Application Publication
(10) Pub. No.: US 2014/0139923 A1
(43) Pub. Date: May 22, 2014

(54) DIFFRACTION OPTICAL ELEMENT AND MANUFACTURING METHOD THEREFOR

(71) Applicant: PANASONIC CORPORATION, Kadomaa-shi, Osaka (JP)

(72) Inventors: Akiko Murata, Osaka (JP); Yuka Okada, Hyogo (JP); Tatsutoshi Suenaga, Osaka (JP)

(21) Appl. No.: 14/130,737

(22) PCT Filed: May 24, 2013
(86) PCT No.: PCT/JP2013/003298

§ 371 Date: Jan. 3, 2014

(30) Foreign Application Priority Data
May 25, 2012 (JP) 2012-119921

(51) Int. Cl. G02B 5/18; B05D 5/06

(52) U.S. Cl. CPC G02B 5/18; B05D 5/06
USPC 359/576; 427/164

(57) ABSTRACT

A diffractive optical element disclosed in the present application includes: a base which is made of a first optical material containing a first resin and which has a diffraction grating in its surface; and an optical adjustment layer which is made of a second optical material containing a second resin and inorganic particles and which is provided on the base so as to cover the diffraction grating, wherein ΔSP which is defined by a formula shown below is not less than −0.7 and not more than +0.7 [cal/cm³]^{1/2}:

ΔSP=[a solubility parameter of the second resin]−[a solubility parameter of the first resin], and

a design order of diffraction caused by the diffraction grating is n^{th} order, and unwanted order diffracted light of n+1^{th} order in a wavelength range of not less than 400 nm and not more than 700 nm is not more than 7%.

### TECHNICAL FIELD

The present application relates to a diffractive optical element and relates to a diffractive optical element which is formed by two or more members containing different resins.

### BACKGROUND ART

The diffractive optical element has such a configuration that a diffraction grating that diffracts light is provided on a base which is made of glass or resin. The diffractive optical element has been used for an optical system in a variety of optical devices, including imaging devices and optical recording devices. Known examples of the diffractive optical element include a lens which is designed to focus diffracted light of a specific order into a single point, a spatial low pass filter, and a polarization hologram element.

The diffractive optical element has the advantage of enabling a compact optical system. Since the diffractive optical element more largely diffracts light of a longer wavelength contrary to refraction, the chromatic aberration and the image plane curvature of the optical system can be improved by combining a diffractive optical element and a usual optical element which utilized refraction.

However, theoretically, the diffraction efficiency depends on the wavelength of light, and therefore, when a diffractive optical element is designed such that the diffraction efficiency with light of a specific wavelength is optimum, there is a problem that the diffraction efficiency decreases with light of the other wavelengths. For example, when a diffractive optical element is used for an optical system which utilizes white light, such as a lens for cameras, this wavelength dependence of the diffraction efficiency causes color mottling or flare due to light of unwanted orders, so that it is difficult to construct an optical system which has appropriate optical characteristics only with a diffractive optical element.

Patent Document 1 discloses such a solution to the above problem that a diffraction grating is provided over the surface of a base which is made of an optical material, and the diffraction grating is covered with an optical adjustment layer which is made of a different material from the base, whereby a phase-difference type diffractive optical element is constructed. Two optical materials are selected such that the optical characteristics meet predetermined conditions, whereby the diffraction efficiency at a designed diffraction order is increased irrespective of the wavelength, i.e., the wavelength dependence of the diffraction efficiency is reduced.

Where the wavelength of light passing through the diffractive optical element is λ, the refractive indices of the two types of optical materials at the wavelength λ are n1 (λ) and n2(λ), and the depth of the diffraction grating is d, the diffraction efficiency for light of wavelength λ is 100% when the following formula (1) is satisfied:

$$\begin{matrix}[ Expression 1 ] & \\ d = \frac{m λ}{\vert n 1 ( λ ) - n 2 ( λ ) \vert} & ( 1 )\end{matrix}$$

where m is an integer which represents the diffraction order.

Therefore, to reduce the wavelength dependence of the diffraction efficiency, an optical material of refractive index n1(λ) and an optical material of refractive index n2(λ) which have such a wavelength dependence that d is generally constant within the wavelength band of used light may be combined. Commonly, a material which has high refractive index and low wavelength dispersion and a material which has low refractive index and high wavelength dispersion are combined. Patent Document 1 discloses using glass or resin as the first optical material for the base and using a UV-curable resin as the second optical material.

When glass is used as the first optical material for the base, micromachining is difficult as compared with a resin, and narrowing the pitch of the diffraction grating to improve the diffraction performance is not easy. For this reason, it is difficult to improve the optical performance while reducing the size of the optical element. Since the molding temperature of the glass is higher than that of the resin, the durability of a die for molding of glass is lower than that of a die for molding of the resin, and there is also a problem in productivity.

On the other hand, when a resin is used as the first optical material for the base, the resin is better than glass in respect of processibility and moldability of the diffraction grating. However, it is difficult to realize various values of the refractive index as compared with glass, and the difference in refractive index between the first optical material and the second optical material is small. Therefore, the depth of the diffraction grating, d, is large as clearly seen from Formula (1).

As a result, although the processibility of the base itself is excellent, it is necessary to deeply machining a die which is used for formation of the diffraction grating and to mold the edge of a groove so as to have a sharply-tapered shape, so that processing of the die is difficult. Further, as the diffraction grating is deeper, it is necessary to increase the pitch of the diffraction grating because of restrictions in processing of at least one of the base and the die. Therefore, the number of diffraction gratings cannot be increased, and the restrictions in designing of the diffractive optical element become large.

To solve such problems, the applicant of the present application proposes using a composite material, in which inorganic particles with an average particle diameter of 1 nm to 100 nm are contained in a matrix resin, as the optical adjustment layer in Patent Document 2. This composite material is advantageous in that the refractive index and the Abbe number can be controlled according to the material of the inorganic particles dispersed and the amount of inorganic particles added, so that the refractive index and the Abbe number which could not be realized by conventional resins can be obtained. Therefore, by using the composite material for the optical adjustment layer, the design flexibility of the diffraction grating for the case where a resin is used as the first optical material for the base is improved, and the moldability is improved, and at the same time, the wavelength characteristics with excellent diffraction efficiency can be obtained.

### CITATION LIST

### Patent Literature

Patent Document 1: Japanese Laid-Open Patent Publication No. 10-268116
Patent Document 2: WO 07/026,597

### SUMMARY OF INVENTION

### Technical Problem

The inventors of the present application researched in detail the configuration of a diffractive optical element in which resins are used for the base and the optical adjustment layer and manufacturing thereof. As a result, it was found that, in a diffractive optical element in which resins are used for the base and the optical adjustment layer, entrapment of air bubbles occurs in an orbicular zone portion of the diffraction grating during manufacture, or the adhesive property between the optical adjustment layer and the base is not sufficient in some cases.

A nonlimiting exemplary embodiment of the present application provides a diffractive optical element in which the base and the optical adjustment layer are adhered at a desirable strength, and entrapment of air bubbles in the orbicular zone portion is prevented.

### Solution to Problem

A diffractive optical element which is an embodiment of the present invention includes: a base which is made of a first optical material containing a first resin and which has a diffraction grating in its surface; and an optical adjustment layer which is made of a second optical material containing a second resin and inorganic particles and which is provided on the base so as to cover the diffraction grating, wherein ΔSP which is defined by a formula shown below is not less than −0.7 and not more than +0.7 [cal/cm³]^{1/2}, and a design order of diffraction caused by the diffraction grating is n^{th} order, and unwanted order diffracted light of n+1^{th} order in a wavelength range of not less than 400 nm and not more than 700 nm is not more than 7%.

### Advantageous Effects of Invention

According to a diffractive optical element disclosed in the present application, entrapment of air bubbles between the optical adjustment layer and the base is prevented, and the adhesive property between the optical adjustment layer and the base is improved.

### BRIEF DESCRIPTION OF DRAWINGS

FIG. 1(a) is a diagram schematically showing a cross-sectional configuration of a diffractive optical element of the present invention. FIG. 1(b) is a diagram schematically showing a top view. FIG. 1(c) is a graph showing the luminance of diffracted light of respective diffraction orders in the case where a light ray passes through the diffractive optical element of the present invention.

FIG. 2 is an enlarged cross-sectional view of the diffractive optical element shown in FIG. 1.

FIG. 3 is a graph for illustrating the definition of the effective particle diameter of particles.

FIGS. 4(a) to 4(e) are cross-sectional views of steps illustrating an example of a manufacturing method of the diffractive optical element shown in FIG. 1.

### DESCRIPTION OF EMBODIMENTS

When a resin is used as a constituent material of an optical element, the range of the refractive index and the range of the wavelength dependence of the refractive index in which a resin can be selected are narrow as compared with inorganic materials, such as glass, ceramics, etc. Therefore, in the case where a resin is used for the base, it is very difficult to select a resin which can realize an optical adjustment layer that satisfies formula (1) and that satisfies required refractive index characteristics. The inventors of the present application examined forming an optical adjustment layer which satisfies such conditions using a composite material which is composed of a resin containing inorganic particles and realizing a practical diffractive optical element which has high diffraction efficiencies over a wide wavelength range.

Commonly, in the case where a material which contains an uncured resin is applied over a base which is made of a resin and is molded, the extension and spread of the applied material vary depending on the shape and size of an orbicular zone of a diffraction grating formed over the base surface, the type and viscosity of the applied material, and the wettability of the material to the base, so that air bubbles are caught between the orbicular zone and the applied material in some cases. Such air bubbles constitute a cause of stray light or scattered light and produce a deterioration in the optical characteristics of the diffractive optical element.

As a result of the detailed research carried out by the inventors of the present application, it was found that entrapment of air bubbles in an orbicular zone portion of the diffraction grating and the adhesive property between the base and the optical adjustment layer depend on the solubility parameter (SP value) of the applied material. Specifically, when the wettability of a resin contained in the applied material to a base that has an orbicular zone diffraction grating which has a step of about 1 μm to 20 μm is low, i.e., when the SP value is low or when the viscosity is low, air is likely to be involved, so that entrapment of air bubbles in the diffraction grating occurs.

On the other hand, it was found that, when the wettability of a resin contained in the applied material is high, i.e., when the SP value is high, the probability of entrapment of air bubbles in the diffraction grating decreases while, however, the compatibility also decreases, and therefore, the adhesive property to the base also decreases.

Here, the solubility parameter is a square root of the cohesive energy density in the regular solution theory. The solubility parameter 6 of a substance is defined using the molar volume V and the cohesive energy ΔE per mole by the following formula (2):

δ=(ΔE/V)^{1/2} (2)

The solubility parameter is an index of the intermolecular force of a substance. Substances between which the difference in solubility parameter is small have high affinity, i.e., exhibit a strong interaction. Although there are various methods for deriving the solubility parameter, a value which is obtained by a calculation method based on a molecular structure formula of Fedors et al., for example, can be used. The solubility parameter used in the specification of the present application is a value which is obtained by a calculation method based on this molecular structure formula. Examples of the structure with which the solubility parameter is high include OH group and high polarity functional group, such as amide bond. On the other hand, examples of the structure with which the solubility parameter is low include fluorine atom, hydrocarbon group, and siloxane bond.

Therefore, in order to prevent entrapment of air bubbles and secure the adhesive property with respect to a base which has a minute structure such as a diffraction grating, selecting a material which has an appropriate SP value with respect to the base is preferred. From these viewpoints, the inventors of the present application mainly researched appropriate resins as the material of the diffractive optical element and arrived at a novel diffractive optical element. The summary of an embodiment of the present invention is as described below.

A diffractive optical element which is an embodiment of the present invention includes: a base which is made of a first optical material containing a first resin and which has a diffraction grating in its surface; and an optical adjustment layer which is made of a second optical material containing a second resin and inorganic particles and which is provided on the base so as to cover the diffraction grating, wherein ΔSP which is defined by a formula shown below is not less than −0.7 and not more than +0.7 [cal/cm³]^{1/2}:

ΔSP=[a solubility parameter of the second resin]−[a solubility parameter of the first resin], and

a design order of diffraction caused by the diffraction grating is n^{th} order, and unwanted order diffracted light of n+1^{th} order in a wavelength range of not less than 400 nm and not more than 700 nm is not more than 7%.

A diffractive optical element which is another embodiment of the present invention includes: a base which is made of a first optical material containing a first resin and which has a diffraction grating in its surface; and an optical adjustment layer which is made of a second optical material containing a second resin and inorganic particles and which is provided on the base so as to cover the diffraction grating, wherein ΔSP which is defined by a formula shown below is not less than −0.7 and not more than +0.7 [cal/cm³]^{1/2}:

ΔSP=[a solubility parameter of the second resin]−[a solubility parameter of the first resin], and

the diffractive optical element does not include, in part of the base on the optical adjustment layer side and part of the optical adjustment layer on the base side, a portion whose refractive index is different from both of refractive indices of the first optical material and the second optical material.

ΔSP may be not less than +0.5 and not more than +0.7 [cal/cm³]^{1/2}

The first resin may contain at least one of polycarbonate and a resin which has a fluorene structure.

The second resin may contain pentaerythritol triacrylate.

The inorganic particles may contain, as a major constituent, at least one selected from the group consisting of zirconium oxide, yttrium oxide, lanthanum oxide, hafnium oxide, scandium oxide, alumina, and silica.

The refractive index of the first optical material may be smaller than the refractive index of the second optical material, and a wavelength dispersibility of the refractive index of the first optical material may be greater than a wavelength dispersibility of the refractive index of the second optical material.

An effective particle diameter of the inorganic particles is not less than 1 nm and not more than 100 nm.

A diffractive optical element manufacturing method which is an embodiment of the present invention includes the steps of: providing a base which is made of a first optical material containing a first resin and which has a diffraction grating in its surface; providing a source material of a second optical material which contains inorganic particles and a source material of a second resin; placing the source material of the second optical material on the base so as to cover the diffraction grating; and curing the source material of the second resin with a die which defines a contour of an optical adjustment layer being pressed against the source material of the second optical material, thereby forming the optical adjustment layer which is made of the second optical material containing the second resin and the inorganic particles, wherein the source material of the second optical material contains substantially no solvent before the step of placing the source material of the second optical material, and ΔSP which is defined by a formula shown below is not less than −0.7 and not more than +0.7 [cal/cm³]^{1/2}:

ΔSP=[a solubility parameter of the second resin]−[a solubility parameter of the first resin].

The step of providing the source material of the second optical material may include the steps of mixing together the inorganic particles dispersed in a solvent and the source material of the second resin, thereby obtaining a mixture, and removing the solvent from the mixture.

A viscosity of the source material of the second optical material which is in an uncured state may be not more than 1000 mPa·s.

The first resin may contain at least one of polycarbonate and a resin which has a fluorene structure.

The second resin may contain pentaerythritol triacrylate.

Hereinafter, specific embodiments of the present invention are described.

### First Embodiment

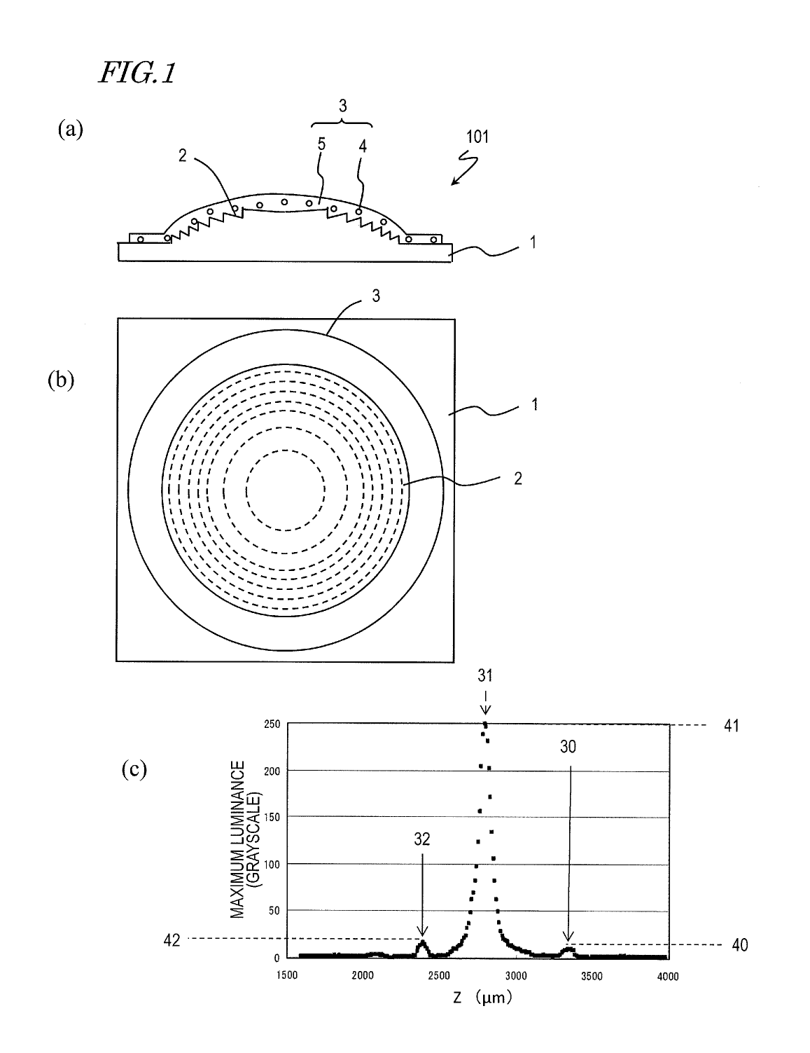

FIG. 1(a) and FIG. 1(b) show a cross-sectional view and top view of the first embodiment of a diffractive optical element of the present invention.

The diffractive optical element 101 includes a base 1 and an optical adjustment layer 3. The base 1 is made of the first optical material which contains the first resin. The optical adjustment layer 3 is made of the second optical material which contains the second resin. By using a composite material in which inorganic particles 4 are dispersed in a matrix resin 5 that contains the second resin, the refractive index and the Abbe number of the second optical material can be controlled.

One principal surface of the base 1 is provided with a diffraction grating 2. The cross-sectional shape, arrangement, pitch, and depth of the diffraction grating 2 are determined according to the optical characteristics of the base 1 and the optical adjustment layer 3 and the optical design of the finally obtained diffractive optical element 101. For example, when the diffraction grating 2 is provided with a lens function, a diffraction grating which has a saw tooth-like cross-sectional shape may be concentrically arranged such that the pitch is continuously varied so as to decrease from the center to the perimeter of the lens. In this case, the diffraction grating may be provided on a curved surface such as shown in FIG. 1(a), or may be provided on a flat surface, so long as the cross-sectional shape, arrangement, and pitch are configured such that a lens function is obtained. Particularly when the diffraction grating 2 is formed on the base 1 such that a surface passing through the tip of the diffraction grating 2 is an aspheric surface which has a lens function, it is possible to select an optimum combination of the refraction function and the diffraction function. As a result, the chromatic aberration and the image plane curvature can be improved in a well-balanced manner, and a lens which has high imaging performance can be obtained. The depth of the diffraction grating 2, d, can be determined using formula (1).

Note that, in FIG. 1(a), a diffractive optical element is shown which has the diffraction grating 2 on one principal surface, although the base 1 may have two or more diffraction grating surfaces. In FIG. 1(a), the base 1 has a convex surface which has the diffraction grating 2 and a flat surface which is opposite to the convex surface, although the two principal surfaces of the base 1 may have convex surfaces on both sides, a convex surface and a concave surface, concave surfaces on both sides, a concave surface and a flat surface, or flat surfaces on both sides, so long as at least either one of these surfaces is provided with a diffraction grating. In this case, the diffraction grating may be provided on only either one of the surfaces or may be provided on both surfaces. When the diffraction grating is provided on both surfaces, the shape, arrangement and pitch of the diffraction grating and the diffraction grating depth may not necessarily be identical on both surfaces so long as the performance required of the diffractive optical element is achieved.

For the purpose of reducing the wavelength dependence of the diffraction efficiency in the diffractive optical element 101, the optical adjustment layer 3 is provided so as to cover the principal surface of the base 1 on which the diffraction grating 2 is provided, such that at least the steps of the diffraction grating 2 are filled.

To reduce the wavelength dependence of the diffraction efficiency, it is preferred that the base 1 and the optical adjustment layer 3 satisfy formula (1) over the entire wavelength range of used light. To this end, it is preferred that the first optical material of the base 1 and the second optical material of the optical adjustment layer 3 have such characteristics that the wavelength dependences of the refractive indices exhibit opposite tendencies and that the variations of the refractive indices with respect to the wavelength cancel each other. More specifically, it is preferred that the refractive index of the first optical material is smaller than the refractive index of the second optical material and that the wavelength dispersibility of the refractive index of the first optical material is greater than the wavelength dispersibility of the refractive index of the second optical material. The wavelength dispersibility of the refractive index is represented by the Abbe number, for example. As the Abbe number increases, the wavelength dispersibility of the refractive index decreases. Therefore, it is preferred that the refractive index of the first optical material is smaller than the refractive index of the second optical material, and at the same time, the Abbe number of the first optical material is smaller than the Abbe number of the second optical material. The wavelength dependences of the refractive indices of the first optical material and the second optical material depend on the physical properties of the first resin and the second resin which are contained in the first optical material and the second optical material, respectively.

Note that, in an actual diffractive optical element, formula (1) does not need to strictly hold true over the entire wavelength range used. If the difference between the right side and the left side of formula (1) is within ±10%, high diffraction efficiency can be obtained at the design order.

As described above, the first optical material that forms the base 1 contains the first resin. The reason why a material which contains a resin is used as the first optical material is that, when considering the die molding by which the highest productivity is expected in production of lenses, the durability of a die used for a material which contains glass is not more than 1/10 of the durability of a die used for a material which contains a resin, so that the manufacture of the base 1 which has a shape of a diffraction grating is not easy, while a manufacturing method of high productivity, such as injection molding, is applicable to a material which contains a resin. Microprocessing of the material which contains a resin is easily realized by die molding or other process methods, and therefore, by decreasing the pitch of the diffraction grating 2, the performance of the diffractive optical element 101 can be improved, and the size of the diffractive optical element 101 can be reduced. Further, the weight of the diffractive optical element 101 can also be reduced.

As the first resin, from among transparent resin materials commonly used for the base of the optical element, a material is selected which has such refractive index characteristics and wavelength dispersibility that the wavelength dependence of the diffraction efficiency at the design order of the diffractive optical element can be reduced. The first optical material may contain, in addition to the first resin, inorganic particles for adjusting the optical characteristics, such as the refractive index, or the mechanical characteristics, such as thermal expansibility, or an additive that absorbs electromagnetic waves within a specific wavelength range, such as dye or pigment.

Likewise, the second optical material that forms the optical adjustment layer 3 contains the second resin. The reason why a material which contains a resin is used as the second optical material is that the moldability of the optical adjustment layer 3 that fills the steps of the diffraction grating 2 is excellent. Furthermore, the molding temperature is low as compared with inorganic materials, and therefore, it is particularly preferred when the base 1 is made of the first optical material that contains the first resin.

Furthermore, by dispersing the inorganic particles which have high refractive index throughout the matrix resin 5, the second optical material can have high refractive index which could not be achieved solely by a resin.

Therefore, the difference in refractive index between the first optical material and the second optical material can be increased, and as clearly seen from formula (1), the depth of the diffraction grating 2 can be reduced.

In general, the inorganic particles 4 have a higher refractive index than the resin in many cases. In view of such, when the first optical material that contains the first resin is used for the base 1 and the second optical material, in which the inorganic particles 4 are dispersed throughout the matrix resin 5 that contains the second resin, is used as the optical adjustment layer 3, it is preferred that the second optical material is adjusted so as to exhibit a higher refractive index and a lower wavelength dispersibility than the first optical material because there is a wider choice of materials for the inorganic particles 4. In other words, it is preferred that the first optical material has a lower refractive index and higher wavelength dispersibility than the second optical material.

The refractive index of the second optical material that is a composite material can be presumed from the refractive indices of the second resin and the inorganic particles 4 contained in the matrix resin 5 according to the Maxwell-Garnett theory which is expressed by, for example, formula (3) shown below.

In formula (3), n_{COM}λ is the average refractive index of the second optical material at a specific wavelength λ, and nₚλ and nₘλ are the refractive indices of the inorganic particles and the second resin, respectively, at this wavelength λ. P is the volume ratio of the inorganic particles to the whole second optical material. In formula (3), by presuming the refractive indices at D-line (589.2 nm), F-line (486.1 nm), C-line (656.3 nm) of Fraunhofer as the wavelength λ, the Abbe number of the composite material can be further presumed. The mixture ratio of the second resin and the inorganic particles 4 may be determined in reverse from the presumption that is based on this theory.

$$\begin{matrix}[ Expression 3 ] & \\ {n}_{COM λ}^{2} = \frac{{n}_{p λ}^{2} + 2 {n}_{m λ}^{2} + 2 P ( {n}_{p λ}^{2} + 2 {n}_{m λ}^{2} )}{{n}_{p λ}^{2} + 2 {n}_{m λ}^{2} - P ( {n}_{p λ}^{2} + 2 {n}_{m λ}^{2} )} {n}_{m λ}^{2} & ( 3 )\end{matrix}$$

Note that when in formula (3) the inorganic particles 4 absorb light or the inorganic particles 4 contain a metal, the refractive index of formula (3) is calculated as a complex refractive index. Formula (3) is a formula which holds true when nₚλ≧nₘλ. When nₚλ<nₘλ, the refractive index is presumed using formula (4) shown below:

$$\begin{matrix}[ Expression 4 ] & \\ {n}_{COM λ}^{2} = \frac{{n}_{m λ}^{2} + 2 {n}_{p λ}^{2} + 2 ( 1 - P ) ( {n}_{m λ}^{2} + 2 {n}_{p λ}^{2} )}{{n}_{m λ}^{2} + 2 {n}_{p λ}^{2} - ( 1 - P ) ( {n}_{m λ}^{2} + 2 {n}_{p λ}^{2} )} {n}_{p λ}^{2} & ( 4 )\end{matrix}$$

When using a composite material as the second optical material, the difference in refractive index between the base 1 and the optical adjustment layer 3 can be increased, and the largeness of the steps of the diffraction grating provided in the base can be reduced. Therefore, in the case of fabricating the base 1 by molding, the transferability of the diffraction grating 2 improves. Further, the steps of the diffraction grating 2 can be shallower, and therefore, the transfer is easy even when the pitch of the steps is narrowed. Thus, the diffraction performance can be improved by narrowing the pitch of the diffraction grating 2. Furthermore, materials which have various physical properties can also be used for the second resin, and accordingly, it is easier to make the optical characteristics and the other physical or scientific properties than the optical characteristics compatible.

The first resin and the second resin are selected from known resin materials such that the first optical material and the second optical material have desired refractive indices and desired wavelength dependences as described above. Further, the materials are selected such that the difference in the SP value between the first optical material and the second optical material, ΔSP, is not less than −0.7 and not more than +0.7 [cal/cm³]^{1/2} relative to the solubility parameter of the first resin. That is, ΔSP that is defined by the following formula is not less than −0.7 and not more than +0.7 [cal/cm³]^{1/2}:

ΔSP=[Solubility Parameter of Second Resin]−[Solubility Parameter of First Resin]

As will be described in detail in the inventive examples below, due to a small difference in solubility parameter between the first resin and the second resin, the first resin and the second resin have generally equal intermolecular forces, and the first optical material and the second optical material that respectively contain the first resin and the second resin have high affinity so that they readily adhere to each other.

Entrapment of air bubbles between the base 1 and the optical adjustment layer 3 has an association with the wettability at the surface at which the base and the optical adjustment layer 3 are in contact with each other. One of the factors of the wettability is the surface tension. An example of the factors which determines the surface tension is the SP value. According to the diffractive optical element of the present embodiment, ΔSP between the first resin and the second resin is not less than −0.7 and not more than +0.7 [cal/cm³]^{1/2} as described above, so that entrapment of air bubbles is prevented.

Particularly when the difference of the SP value between the first optical material and the second optical material, ΔSP, is in the range of not less than +0.5 and not more than +0.7 [cal/cm³]^{1/2}, the solubility parameter of the second resin that is contained in the optical adjustment layer 3 is larger. Therefore, the wettability of the optical adjustment layer 3 is further increased, and entrapment of air bubbles in the diffraction grating can be prevented without depending on the molding speed of the optical adjustment layer 3. Thus, a diffractive optical element which has more excellent optical characteristics can be realized.

As described above, entrapment of air bubbles also depends on the viscosity of the second optical material that forms the optical adjustment layer 3, and entrapment of air bubbles is also likely to occur when the viscosity of the second optical material is low. As will be described later in the inventive examples below, when the second optical material does not contain inorganic particles, the viscosity of the second optical material is low so that entrapment of air bubbles is likely to occur. The above-described ΔSP represents a relationship that the solubility parameters of the first resin and the second resin satisfy when the second optical material contains the second resin and inorganic particles.

Assuming that in the diffractive optical element of the present embodiment the design order of the diffraction caused by the diffraction grating 2 is the n^{th} order, unwanted diffracted light of the (n+1)^{th} order in the wavelength range of not less than 400 nm and not more than 700 nm is not more than 7% in the following formula 5:

$$\begin{matrix}[ Expression 5 ] & \\ \begin{matrix}{( n + 1 )}^{th} order \\ diffraction \\ efficiency\end{matrix} = \frac{Luminance of {( n + 1 )}^{th} order diffracted light}{\begin{matrix}Luminance of \\ {n}^{th} order \\ diffracted light\end{matrix} + \begin{matrix}Luminance of \\ {( n + 1 )}^{th} order \\ diffracted light\end{matrix} + \begin{matrix}Luminance of \\ {( n - 1 )}^{th} order \\ diffracted light\end{matrix}} & ( 5 )\end{matrix}$$

As an example, the results of measurement of the maximum luminances 40, 41, 42 at light condensing points 30, 31, 32 corresponding to the respective diffraction orders in the case where a light ray is allowed to pass through the diffractive optical element are shown in FIG. 1(c). In FIG. 1(c), the light condensing point 31 represents the 0^{th} order diffracted light, and the light condensing point 32 and the light condensing point 30 represent the −1^{st} order diffracted light and the +1^{st} order diffracted light, respectively. The light condensing points 30, 31, 32 have the maximum luminances 40, 41, 42, respectively. By assigning the maximum luminances in formula (5), the (n+1)^{th} order diffraction efficiency can be obtained.

There are various possible causes of occurrence of unwanted diffracted light. Among others, it is considered that, when the diffraction grating 2 in the diffractive optical element 101 is not shaped as designed, and when the optical characteristics of the base 1 and the optical adjustment layer 3 are not as designed, unwanted diffracted light is likely to occur.

When the first optical material and the second optical material of the base 1 and the optical adjustment layer 3 of the diffractive optical element contain resins, at least one of the first optical material and the second optical material is in an uncured state or is deformable to such an extent that it is moldable during manufacture of the diffractive optical element. Therefore, there is a probability that chemical interaction occurs between the first resin of the first optical material and the second resin of the second optical material, and the optical characteristics of the first optical material and the second optical material vary.

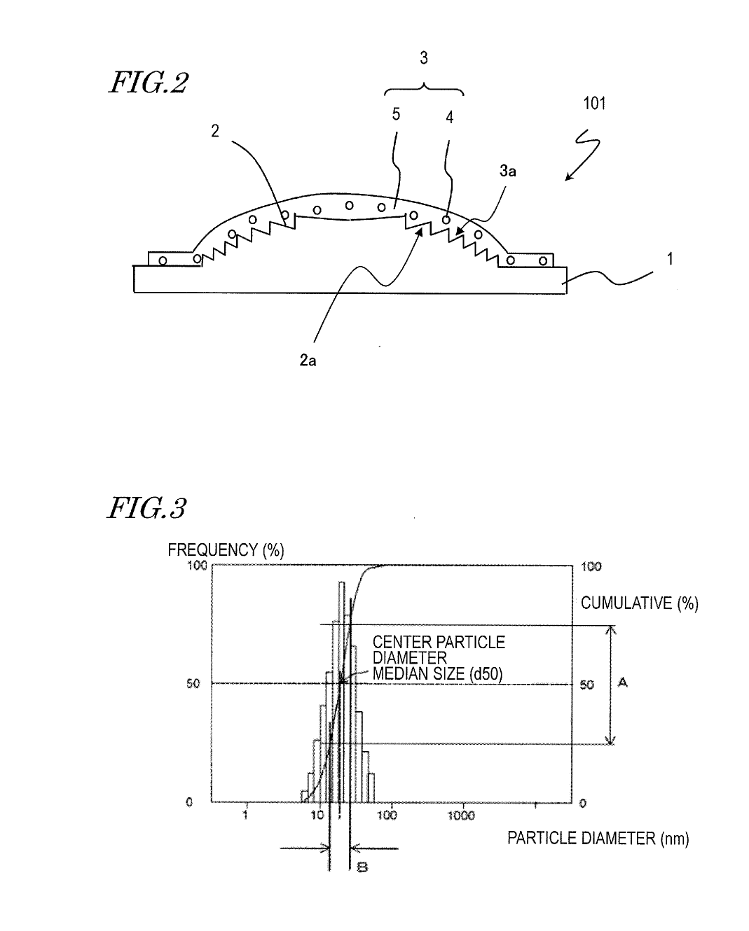

According to the diffractive optical element 101 of the present embodiment, as shown in FIG. 2, the diffractive optical element 101 does not include, in a region 2a of the base 1 on the optical adjustment layer 3 side and a region 3a of the optical adjustment layer 3 on the base 1 side, a portion whose refractive index is different from both of the refractive indices of the first optical material and the second optical material. Here, the statement “not include a portion whose refractive index is different from both of the refractive indices of the first optical material and the second optical material” means that, in TEM (transmission electron microscope) observation, another layer or region cannot be visually detected between the base 1 and the optical adjustment layer 3. That is, the first optical material and the second optical material do not produce chemical interaction to such an extent that the optical characteristics are affected. This is because, as will be described in detail in the section of the second embodiment, in manufacture of the diffractive optical element 101, such a process is employed that interaction between the first resin of the first optical material and the second resin of the second optical material is prevented. Thus, as described above, occurrence of unwanted diffracted light is prevented, and a diffractive optical element which has excellent optical characteristics can be realized.

As for the first optical material that forms the base 1, when the second optical material that is realized by a composite material which has a high refractive index and low wavelength dispersibility is used as the optical adjustment layer 3, it is preferred that the first resin of the first optical material that forms the base 1 has a low refractive index and high wavelength dispersibility. Polycarbonates which have an aromatic ring (such as bisphenol A-based polycarbonates and bisphenol F-based polycarbonates) and resins which include a fluorene structure (for example, “OKP” products manufactured by Osaka Gas Chemicals Co., Ltd.) have relatively low Abbe numbers and are suitable in view of adjustment of the wavelength dispersibility of the refractive index. Note that, however, when necessary, a copolymer of a polycarbonate-based resin and another resin, an alloy of a polycarbonate-based resin with another resin, or a blend of a polycarbonate-based resin with another resin may be used as the first optical material such that formula (1) is satisfied between the first optical material and the second optical material. Further, the first optical material may contain an additive.

As the second resin, a thermosetting resin or an energy ray-curable resin is preferably used because it will facilitate the process of forming the optical adjustment layer 3. Specifically, an acrylate resin, a methacrylate resin, an epoxy resin, an oxetane resin, or an ene-thiol resin may be used.

Particularly when polycarbonate is used for the first resin, for the purpose of making the value of ΔSP fall within the range of not less than −0.7 and not more than +0.7 [cal/cm³]^{1/2}, a resin whose SP value is significantly different from that of the polycarbonate may be mixed in so that adjustment of the SP value is facilitated. Particularly, a resin which contains pentaerythritol triacrylate that has a SP value of 11.5 [cal/cm³]^{1/2}, which is significantly different from that of polycarbonate or a resin which includes a fluorene structure, is preferably used.

The second resin may be realized by an alloy or blend of the above-described resins. Particularly, it is preferred that the above-described resin is contained in the second resin in the proportion of 20 weight % or more. Alternatively, denatured products of these resins may be used.

As described above, in the case where the second optical material which is realized by a composite material is used as the optical adjustment layer 3, the second optical material needs to have a higher refractive index than that of the first optical material and, at the same time, have lower wavelength dispersibility than that of the first optical material. Therefore, it is preferred that the inorganic particles 4, which are dispersed in the second resin, contain a material which has low wavelength dispersibility, i.e., a material which has a large Abbe number, as a major constituent. Particularly when a polycarbonate-based resin which has a benzene ring or a resin which includes a fluorene structure is used as the first resin, it is preferred that the major constituent of the inorganic particles 4 is a material whose Abbe number is not less than 25. For example, it is particularly preferred that the major constituent is at least one oxide selected from the group consisting of zirconium oxide (Abbe number: 35), yttrium oxide (Abbe number: 34), lanthanum oxide (Abbe number: 35), hafnium oxide (Abbe number: 32), scandium oxide (Abbe number: 27), alumina (Abbe number: 76), and silica (Abbe number: 68). Alternatively, a composite oxide of these oxides may be used. In a wavelength band of light in which the diffractive optical element 101 is used, inorganic particles which exhibit high refractive indices, typified by titanium oxide and zinc oxide, for example, may further be allowed to coexist in addition to these inorganic particles so long as formula (1) is satisfied.

The effective particle diameter of the inorganic particles 4 is preferably not less than 1 nm and not more than 100 nm. When the effective particle diameter is not more than 100 nm, the loss caused by Rayleigh scattering is reduced, and the transparency of the optical adjustment layer 3 can be increased. When the effective particle diameter is not less than 1 nm, the effect such as emission caused by the quantum effects can be prevented. When necessary, the second optical material may further contain a dispersing agent for improving the dispersibility of the inorganic particles or an additive such as a polymerization initiator agent, a labelling agent, etc.

Now, the effective particle diameter is described with reference to FIG. 3. In FIG. 3, the horizontal axis represents the particle diameter of the inorganic particles. The vertical axis on the left side represents the frequency of the inorganic particles with respect to the particle diameter on the horizontal axis. The vertical axis on the right side represents the cumulative frequency of the particle diameter. The effective particle diameter refers to the particle diameter range B corresponding to the range A that has the cumulative frequency of 50% around the center particle diameter that refers to a particle diameter with which the cumulative frequency is 50% in the particle diameter frequency distribution of all the inorganic particles (median size: d50). Thus, it is preferred that the range of the thus-defined effective particle diameter of the inorganic particles 4 is within the range of not less than 1 nm and not more than 100 nm. To accurately determine the value of the effective particle diameter, for example, measuring 200 or more inorganic particles is preferred.

It is also preferred that the second optical material contains a silane coupling agent as the dispersing agent for uniformly dispersing the above-described inorganic particles. The dispersing agent has the function of preventing coagulation of particles so as to improve the transparency of the optical adjustment layer. Examples of the silane coupling agent include acrylsilane, vinylsilane, and epoxysilane. An example of acrylsilane is γ-methacryloxypropyltrimethoxysilane. When an acrylate resin is used for the second optical material, using a silane coupling agent which has an acrylic group is preferred.

Particularly when using a composite material as the optical adjustment layer, the diffraction grating depth is reduced, and the processing is facilitated. As the diffraction grating depth decreases, the distance to an adjacent diffraction grating can be reduced, i.e., the pitch can be narrowed, so that a high diffraction effect can be achieved. Thus, a high-performance diffractive optical element can be realized.

According to the diffractive optical element of the present embodiment, the difference between the solubility parameter of the first resin and the solubility parameter of the second resin, ΔSP value, is not less than −0.7 and not more than +0.7 [cal/cm³]^{1/2}. Therefore, in forming the optical adjustment layer, entrapment of air bubbles is prevented.

A diffractive optical element can be obtained in which, even in a severe use environment, a desirable adhesion state can be maintained so that the optical adjustment layer would not peel off from the base, and which has high reliability, light weight, and excellent optical characteristics. Since a resin is used for the base, molding is relatively easily achieved, and the lifetime of the die can be increased. Therefore, the diffraction grating element of the present embodiment is excellent in mass productivity. Because of such features, the diffractive optical element of the present embodiment is suitably used as an optical element for, for example, optical devices which are to be installed in a place where the environmental temperature variation or vibration is large, more specifically surveillance cameras which are to be installed outdoor and in-vehicle cameras for motorcars.

In the diffractive optical element 101 of the present embodiment, an antireflection layer may be provided on the surface of the optical adjustment layer 3. The material of the antireflection layer is not particularly limited so long as it has a smaller refractive index than that of the optical adjustment layer 3. For example, either one of a resin or a composite material of a resin and inorganic particles, or an inorganic thin film formed by vacuum evaporation, for example, may be used. Examples of the inorganic particles used in the composite material as the antireflection layer include silica, alumina, and magnesium oxide, which have small refractive indices. Alternatively, an antireflection shape of a nanostructure may be formed in the surface of the optical adjustment layer 3. The antireflection shape of a nanostructure can be easily formed by, for example, a transfer technique with the use of a die (nanoimprinting). Further, a surface layer which has the function of adjusting the mechanical characteristics, such as abrasion resistance, thermal expansibility, etc., may be separately provided on the surface of the optical adjustment layer 3 or the antireflection layer. Furthermore, a surface layer which has the function of adjusting the mechanical characteristics, such as abrasion resistance, thermal expansibility, etc., may be separately provided on the surface of the optical adjustment layer 3 or the antireflection layer.

### Second Embodiment

Hereinafter, an embodiment of the manufacturing method of the diffractive optical element of the present invention is described.

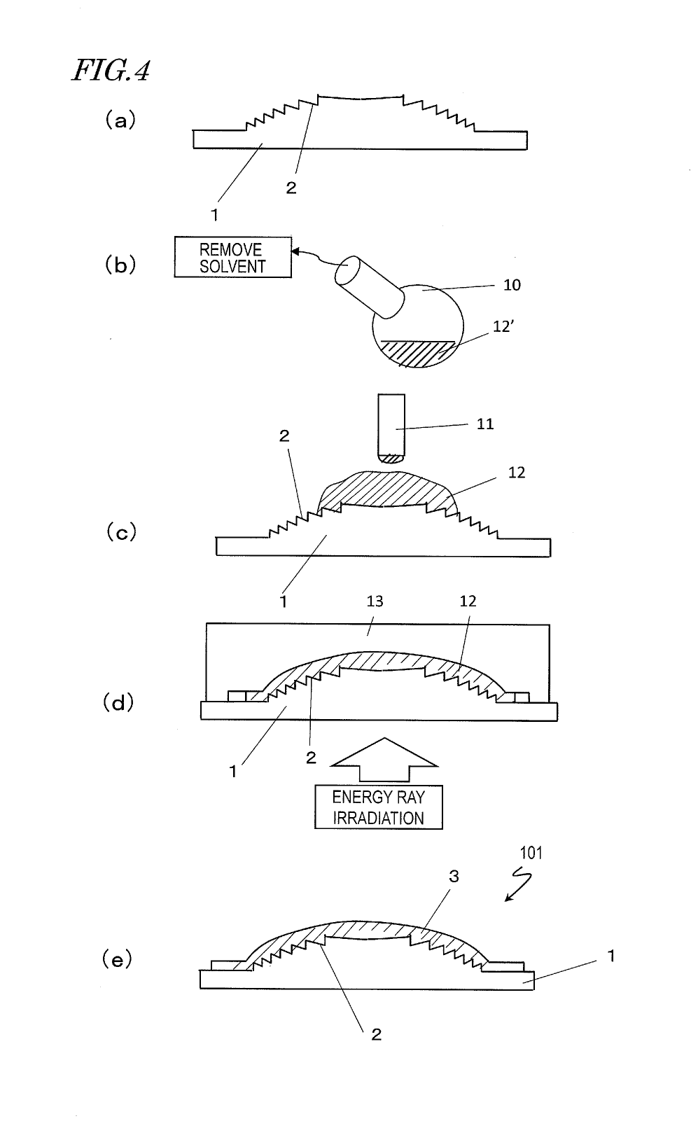

First, as shown in FIG. 4(a), a base 1 is provided which has a diffraction grating 2 over its surface. The base 1 which has the diffraction grating 2 can be fabricated by the following methods. The softened or melted first optical material is supplied into a die which has a diffraction grating shape so as to be molded, typified by injection molding and press molding, for example. Alternatively, a monomer or oligomer which is a source material of the first optical material is poured into a die which has a diffraction grating shape, and the source material is polymerized by heating and/or energy ray irradiation. Still alternatively, the diffraction grating 2 is formed by cutting or abrasion in the surface of the base 1 which has been molded in advance. The base 1 which has the diffraction grating 2 may be fabricated by the other methods than those described herein.

Then, the source material of the second optical material, containing the source materials of the inorganic particles and the second resin, is provided. As previously described in the first embodiment, inorganic particles which are selected according to the optical characteristics which are required of the second optical material can be used. As for the second resin, the source material of the second optical material, containing the source material of the second resin whose ΔSP is not less than −0.7 and not more than +0.7 [cal/cm³]^{1/2}, i.e., whose solubility parameter is not less than −0.7 and not more than +0.7 [cal/cm³]^{1/2} relative to the solubility parameter of the first resin contained in the first optical material, is provided.

When the second resin is mixed with the inorganic particles to form a composite, it is preferred to select the resin such that the composite has such a viscosity that it can be applied onto the base 1 and entrapment of air bubbles in the diffraction grating is prevented. It is particularly preferred that the viscosity of the composite which is in an uncured state is not more than 1000 mPa·s. When a plurality of resins are mixed together, it is preferred that the viscosity of the resin mixture is not more than 1000 mPa·s. Note that, in general, the viscosity η of the mixed resin (the mixed viscosity of resin A and resin B) can be calculated by the following formula (6):

log η=C_{A}·log η_{A}+C_{B}19 log η_{b} (6)

where C_{A} and C_{B} are the weight fractions (%) of the respective resins, and η_{A} and η_{B} are the viscosities of the respective resins.

It is preferred that the source material of the second optical material, containing the source materials of the inorganic particles and the second resin, contains substantially no solvent before being placed on the base 1. Here, the state of containing substantially no solvent means that the content of the solvent with respect to the total weight of the source material of the second optical material is not more than 0.3%.

Thus, since the source material of the second optical material contains substantially no solvent, chemical interaction between the first optical material and the second optical material in manufacture of the diffractive optical element is prevented, and formation of a layer or region whose refractive index is different from both of the refractive indices of the first optical material and the second optical material can be prevented. Further, generation of cracks or the like due to deterioration in the strength of the optical adjustment layer which would occur when a solvent is remaining can be prevented.

The source material of the second optical material which contains substantially no solvent may be obtained by, for example, dispersing the inorganic particles throughout the source material of the second resin which contains substantially no solvent.

In the case where it is difficult to uniformly disperse the inorganic particles throughout the source material of the second resin, the inorganic particles may be dispersed throughout the source material of the second resin by mixing the inorganic particles with a solvent and mixing together a mixture solution and the source material of the second resin. In that case, the solvent may be one which can readily be removed from the source material of the second resin in which the inorganic particles are dispersed. For example, isopropyl alcohol (IPA), or the like, may be used.

To remove the solvent, for example, an evaporator may be used. Specifically, as shown in FIG. 4(b), a source material 12′ of the second optical material which contains a solvent is put into a flask 10, and the pressure is reduced while warming the source material 12′ by a water bath, or the like, such that the solvent is removed to such a state that the source material 12′ contains substantially no solvent.

Then, as shown in FIG. 4(c), a source material 12 of the second optical material is placed on the base 1 so as to cover the diffraction grating 2.

The method for placing the source material 12 of the second optical material on the diffraction grating 2 of the base 1 may be selected from a variety of known coating layer formation processes according to the shape accuracy of the diffraction grating 2 which is determined based on the material properties, such as viscosity, and the optical characteristics required of the diffractive optical element. For example, application with the use of a liquid injection nozzle such as a dispenser, immersion application such as dip coating, ejection application such as spray coating and an inkjet method, application by means of rotation such as spin coating, or application by means of squeezing such as screen printing may be used. Alternatively, an appropriate combination of these processes may be employed. This point also applies to the inventive examples which will be described later.

In this process, since ΔSP between the first resin and the second resin is not less than −0.7 and not more than +0.7 [cal/cm³]^{1/2} as previously described in the first embodiment, in applying the source material 12 of the second optical material onto the diffraction grating of the base 1, air which is present between the base 1 and the source material 12 is purged along the surface of the base 1 or the surface of the source material 12 so that entrapment of air bubbles is prevented.

When the shape accuracy which is required of the optical adjustment layer 3 is high, particularly when it is necessary to mold the shape of a surface opposite to the diffraction grating 2 with high accuracy, the shape of the optical adjustment layer 3 may be controlled with higher molding accuracy using a die in the curing step. As shown in FIG. 4(c), the source material 12 of the optical adjustment layer, from which the solvent has been removed, is dropped from a dispenser 11 onto the base 1. Then, as shown in FIG. 4(d), a die 13 is pressed against the source material 12, and the die 13 is placed on the base 1 so as to cover the source material 12. The material of the die 13 may be appropriately selected according to the required shape accuracy and durability. For example, a metal, such as iron or aluminum, an alloy of these metals, brass, etc., can be used. When necessary, a metal which has undergone a surface treatment, such as nickel plating, may be used. Also, it is possible to use quartz or glass, or a resin such as an epoxy resin, a polyester resin, a polyolefin resin, or the like, as the material of the die 13.

In the case where the shape of the optical adjustment layer 3 is molded using the die 13, the source material 12 of the second optical material may be placed inside the die 13 and thereafter pressed against the base 1. However, since the source material 12 has low viscosity before being cured, the source material 12 is likely to flow around to the base 1 that has the diffraction grating 2 in its surface, so that entrapment of air bubbles is prevented, and at the same time, the adhesive property between the optical adjustment layer 3 and the base 1 after being cured is high. Thus, directly placing the source material 12 on the base 1 is more preferred.

In the case where the optical adjustment layer 3 is molded using the die 13, it is common that the die is removed after the curing step. However, if the source material 12 does not deform before being cured, the die may be removed before curing the source material of the second resin contained in the source material 12. In the case where the die is removed after curing of the material by energy ray irradiation, the source material of the second resin contained in the source material 12 is irradiated with an energy ray with the source material 12 being restricted by the die 13. When a nontransparent material, such as a metal, is used as the die 13, the energy ray is supplied through a surface of the base 1 which is opposite to the surface on which the source material 12 is placed as shown in FIG. 4(d). On the other hand, when a material which is transparent to the energy ray is used as the die 13, e.g., when an ultraviolet ray is used as the energy ray and the die 13 is made of quartz or the like, the second resin can be cured by irradiating the source material of the second resin contained in the source material 12 with an energy ray from the surface of the base 1 on which the source material 12 is placed via the die 13. By curing the source material of the second resin, the entire source material 12 is cured. Thereafter, the die 13 is removed from the cured source material 12, whereby the diffractive optical element 101 that has the optical adjustment layer 3 formed over the surface of the base 1 is completed as shown in FIG. 4(e). In the diffractive optical element 101, the optical adjustment layer 3 adheres to the surface of the base 1 because the difference in solubility parameter between the first resin and the second resin, ΔSP, is small.

When a solvent is contained in the source material 12 of the second optical material, removing the solvent after the source material of the second optical material is placed on the base 1 is a possible option. However, in this case, removal of the solvent requires several minutes to several hours, and therefore, in order to prevent a monomer or oligomer which is the source material of the second resin from permeating into the base 1 in that period, it is necessary to provide as the second resin a material whose solubility parameter is largely different from that of the first resin. On the other hand, according to the manufacturing method of the present embodiment, the source material of the second optical material contains substantially no solvent, and therefore, such permeation of the source material of the second resin or the solvent into the base 1 is prevented. Further, it is not necessary to remove the solvent after the source material of the second optical material is placed on the base 1, and therefore, even though a monomer or oligomer which is the source material of the second resin can permeate into the base 1, the source material of the second optical material can be cured without an interval after the source material of the second optical material is placed on the base 1. Thus, permeation of a monomer or oligomer into the base 1 can be prevented. Further, the production takt for manufacture of the diffractive optical element can also be shortened.

As described above, according to the diffractive optical element manufacturing method of the present embodiment, in placing the source material of the second optical material on the base 1, the source material of the second optical material contains substantially no solvent, and therefore, chemical interaction between the first optical material and the second optical material in manufacture of the diffractive optical element is prevented, and formation of a layer or region whose refractive index is different from both of the refractive indices of the first optical material and the second optical material can be prevented. Since ΔSP is not less than −0.7 and not more than +0.7 [cal/cm³]^{1/2}, entrapment of air bubbles in the diffraction grating of the base 1 during manufacture of diffractive optical element is prevented, and the adhesive property between the base and the optical adjustment layer is improved.

### EXAMPLES

We fabricated diffractive optical elements of the present invention and evaluated the characteristics of the diffractive optical elements. Hereinafter, the results of the evaluation are specifically described.

### 1. Fabrication of Diffractive Optical Elements and Measurement of Characteristics

### Inventive Example 1

The diffractive optical element 101 that had the configuration shown in FIGS. 1(a) and 1(b) was fabricated by the following method. The diffractive optical element 101 had a lens function and was designed to utilize the 1^{st} order diffracted light. This point also applies to the inventive examples which will be described later.

Firstly, by injection molding of a polycarbonate resin (d-line refractive index: 1.585, Abbe number: 28, SP value: 9.8 [cal/cm³]^{1/2}) as the first resin, a base 1 which had a diffraction grating 2 in a shape of an orbicular zone with the depth d of 15 μm in one surface was fabricated on an aspheric shape. The effective radius of the lens portion was 0.828 mm. The number of orbicular zones was 29. The minimum orbicular zone pitch was 14 μm. The near axis R (radius of curvature) of the aspheric surface in which the diffraction was formed was −1.0144 mm.

Then, the composite material that served as the source material of the optical adjustment layer 3 was prepared as follows. The second resin of the second optical material used was a mixture of acrylate resin A (d-line refractive index: 1.529, Abbe number: 50, SP value: 11.5 [cal/cm³]^{1/2}) and acrylate resin B (d-line refractive index: 1.531, Abbe number: 52, SP value: 9.0 [cal/cm³]^{1/2}) in a weight ratio of 5:95.

In this mixture, an IPA dispersion of zirconium oxide (primary particle diameter: 3-10 nm, effective particle diameter based on light scattering method: 6 nm, silane-based surface treatment agent contained) was dispersed such that the weight fraction of zirconium oxide in the total solid components, exclusive of the IPA that is the dispersion medium, was 36 weight %, and mixed together with a photoinitiator.

Thereafter, the solvent in the composite material was thoroughly removed using an evaporator, and the composite material was poured into a syringe while degassing using a vacuum-mixing degassing mixer (V-mini 300 manufactured by EME Corporation).

The optical characteristics of the second optical material after being cured were such that the refractive index at the d-line was 1.623, the Abbe number was 43, and the transmittance of a light ray at the wavelength of 400-700 nm was not less than 90% (film thickness: 30 μm).

As for the refractive index, a film was formed on a flat plate using the source material of the optical adjustment layer 3 under the same conditions, and measurement was carried out using a prism coupler (MODEL 2010 manufactured by Metricon Corporation). The measurement was carried out at three wavelengths (405 nm, 532 nm, 633 nm) in such a manner that refractive indices and Abbe numbers were calculated by an approximation formula using respective refractive index measurement values.

This second optical material was dropped in the amount of 0.4 μL onto the base 1 using a dispenser, and immediately after that, a die (with a nickel plating film formed over a stainless-based alloy surface) was placed thereon, and the material was irradiated with ultraviolet light (illuminance: 120 mW/cm², cumulative amount of light: 4000 mJ/cm²) from the rear surface of the base 1 (a surface of the base 1 which was opposite to the surface on which the composite material was dropped), whereby the second resin was cured. Thereafter, the resultant structure was separated from the die and formed as the optical adjustment layer 3.

The surface shape of the optical adjustment layer 3 was formed so as to be identical with an aspheric shape which accorded with the envelope surface shape at the base of the diffraction grating 2. The optical adjustment layer 3 was formed so as to have a thickness of 30 μm in the maximum thickness portion (i.e., a portion corresponding to the deepest part of the diffractive optical element) and a thickness of 15 μm in the minimum thickness portion (i.e., a portion corresponding to the tip of the diffractive optical element).

The diffraction efficiency of the diffractive optical element 101 that was manufactured through the above-described process was measured. The maximum luminances at light condensing points corresponding to the respective diffraction orders when light rays at respective wavelengths were allowed to pass through the diffractive optical element, using a white light source and color filters (R: 640 nm, G: 540 nm, B: 440 nm), were measured using an ultraprecision 3D measurement apparatus (manufactured by Mitaka Kohki Co., Ltd.), and the diffraction efficiency was calculated by formula 7 shown below. Note that, in the following inventive examples and comparative examples, diffracted light of an order which is equal to or higher than the 3^{rd} order diffracted light was not detected.

$$\begin{matrix}[ Expression 7 ] & \\ \begin{matrix}{1}^{st} order \\ diffraction \\ efficiency\end{matrix} = \frac{Luminance of {1}^{st} order diffracted light}{\begin{matrix}Luminance of \\ {0}^{th} order \\ diffracted light\end{matrix} + \begin{matrix}Luminance of \\ {1}^{st} order \\ diffracted light\end{matrix} + \begin{matrix}Luminance of \\ {2}^{nd} order \\ diffracted light\end{matrix}} & ( 7 )\end{matrix}$$

The 1^{st} order diffraction efficiency of the diffractive optical element 101 of this inventive example was not less than 90% at all of the wavelengths, and the 2^{nd} order diffracted light was 6%. Note that, when the 1^{st} order diffraction efficiency is not less than 85%, it can be said that the diffractive optical element has high light-condensing capacity.

The diffractive optical element 101 was observed using an optical microscope, and no air bubbles were detected within the effective diameter of the diffractive optical element. Further, the diffractive optical element 101 was cut along a cross section including the optical axis, and the boundary portion between the base 1 and the optical adjustment layer 3 was observed using an optical microscope. Neither variation of the diffraction grating due to interaction of the materials nor a refractive index variation layer was detected.

To evaluate the resistance against thermal stress caused by a temperature variation, the reliability test was carried out under an assumption of a severe use environment. Specifically, the diffractive optical element 101 was put into an environmental test chamber (PVL-2SP manufactured by ESPEC Engineering) and stored in such an environment that the temperature was 90° C. and the humidity was 85% for 168 hours. After the storage period, the diffractive optical element was observed using an optical microscope to examine the adhesive property of the optical adjustment layer. No peeling off of the layer was detected within the effective diameter of the diffractive optical element.

### Inventive Example 2

As Inventive Example 2, a diffractive optical element which had the same configuration as that of Inventive Example 1 was manufactured by the same method as that employed for Inventive Example 1. The difference from Inventive Example 1 was that the second resin was prepared by mixing acrylate resin A and acrylate resin B in a weight ratio of 20:80.

The 1^{st} order diffraction efficiency of the diffractive optical element 101 of this inventive example was not less than 92% at all of the wavelengths, and the 2^{nd} order diffracted light was 6%.

The diffractive optical element 101 was observed using an optical microscope, and no air bubbles were detected within the effective diameter of the diffractive optical element. Further, the diffractive optical element 101 was cut along a cross section including the optical axis, and the boundary portion between the base 1 and the optical adjustment layer 3 was observed using an optical microscope. Neither variation of the diffraction grating due to interaction of the materials nor a refractive index variation layer was detected. Furthermore, the adhesive property of the optical adjustment layer was examined by the same method as that employed for Inventive Example 1. No peeling off of the layer was detected within the effective diameter of the diffractive optical element.

### Inventive Example 3

As Inventive Example 3, a diffractive optical element which had the same configuration as that of Inventive Example 1 was manufactured by the same method as that employed for Inventive Example 1. The difference from Inventive Example 1 was that the second resin was prepared by mixing acrylate resin A and acrylate resin B in a weight ratio of 40:60.

The 1^{st} order diffraction efficiency of the diffractive optical element 101 of this inventive example was not less than 90% at all of the wavelengths, and the 2^{nd} order diffracted light was 7%.

The diffractive optical element 101 was observed using an optical microscope, and no air bubbles were detected within the effective diameter of the diffractive optical element. Further, the diffractive optical element 101 was cut along a cross section including the optical axis, and the boundary portion between the base 1 and the optical adjustment layer 3 was observed using an optical microscope. Neither variation of the diffraction grating due to interaction of the materials nor a refractive index variation layer was detected. Furthermore, the adhesive property of the optical adjustment layer was examined by the same method as that employed for Inventive Example 1. No peeling off of the layer was detected within the effective diameter of the diffractive optical element.

### Inventive Example 4

As Inventive Example 4, a diffractive optical element which had the same configuration as that of Inventive Example 1 was manufactured by the same method as that employed for Inventive Example 1. The difference from Inventive Example 1 was that the second resin was prepared by mixing acrylate resin A and acrylate resin B in a weight ratio of 50:50.

The 1^{st} order diffraction efficiency of the diffractive optical element 101 of this inventive example was not less than 91% at all of the wavelengths, and the 2^{nd} order diffracted light was 5%.

The diffractive optical element 101 was observed using an optical microscope, and no air bubbles were detected within the effective diameter of the diffractive optical element. Further, the diffractive optical element 101 was cut along a cross section including the optical axis, and the boundary portion between the base 1 and the optical adjustment layer 3 was observed using an optical microscope. Neither variation of the diffraction grating due to interaction of the materials nor a refractive index variation layer was detected. Furthermore, the adhesive property of the optical adjustment layer was examined by the same method as that employed for Inventive Example 1. No peeling off of the layer was detected within the effective diameter of the diffractive optical element.

### Inventive Example 5

As Inventive Example 5, a diffractive optical element which had the same configuration as that of Inventive Example 1 was manufactured by the same method as that employed for Inventive Example 1. The difference from Inventive Example 1 was that the second resin was prepared by mixing acrylate resin A and acrylate resin B in a weight ratio of 60:40.

The 1^{st} order diffraction efficiency of the diffractive optical element 101 of this inventive example was not less than 91% at all of the wavelengths, and the 2^{nd} order diffracted light was 6%.

The diffractive optical element 101 was observed using an optical microscope, and no air bubbles were detected within the effective diameter of the diffractive optical element. Further, the diffractive optical element 101 was cut along a cross section including the optical axis, and the boundary portion between the base 1 and the optical adjustment layer 3 was observed using an optical microscope. Neither variation of the diffraction grating due to interaction of the materials nor a refractive index variation layer was detected. Furthermore, the adhesive property of the optical adjustment layer was examined by the same method as that employed for Inventive Example 1. No peeling off of the layer was detected within the effective diameter of the diffractive optical element.

### Comparative Example 1

As a comparative example, a diffractive optical element which had the same configuration as that of Inventive Example 1 was manufactured by the same method as that employed for Inventive Example 1. The difference from Inventive Example 1 was that the second resin was prepared by mixing acrylate resin A and acrylate resin B in a weight ratio of 0:100.

The 1^{st} order diffraction efficiency of the diffractive optical element 101 of this comparative example was not less than 90% at all of the wavelengths, and the 2^{nd} order diffracted light was 6%.

The diffractive optical element 101 was observed using an optical microscope, and air bubbles were detected within the effective diameter of the diffractive optical element. Further, the diffractive optical element 101 was cut along a cross section including the optical axis, and the boundary portion between the base 1 and the optical adjustment layer 3 was observed using an optical microscope. Neither variation of the diffraction grating due to interaction of the materials nor a refractive index variation layer was detected. Furthermore, the adhesive property of the optical adjustment layer was examined by the same method as that employed for Inventive Example 1. No peeling off of the layer was detected within the effective diameter of the diffractive optical element.

### Comparative Example 2

As a comparative example, a diffractive optical element which had the same configuration as that of Inventive Example 1 was manufactured by the same method as that employed for Inventive Example 1. The difference from Inventive Example 1 was that the second resin was prepared by mixing acrylate resin A and acrylate resin B in a weight ratio of 70:30.

The 1^{st} order diffraction efficiency of the diffractive optical element 101 of this comparative example was not less than 90% at all of the wavelengths, and the 2^{nd} order diffracted light was 7%.

The diffractive optical element 101 was observed using an optical microscope, and no air bubbles were detected within the effective diameter of the diffractive optical element. Further, the diffractive optical element 101 was cut along a cross section including the optical axis, and the boundary portion between the base 1 and the optical adjustment layer 3 was observed using an optical microscope. Neither variation of the diffraction grating due to interaction of the materials nor a refractive index variation layer was detected. Furthermore, the adhesive property of the optical adjustment layer was examined by the same method as that employed for Inventive Example 1. A peeling off of the layer was detected within the effective diameter of the diffractive optical element.

### Comparative Example 3

As a comparative example, a diffractive optical element which had the same configuration as that of Inventive Example 1 was manufactured by the same method as that employed for Inventive Example 1. The difference from Inventive Example 1 was that the second resin was prepared by mixing acrylate resin A and epoxy acrylate resin C (d-line refractive index: 1.569, Abbe number: 35, SP value: 12.1 [cal/cm³]^{1/2}) in a weight ratio of 90:10, and in this mixture, an IPA dispersion of zirconium oxide (primary particle diameter: 3-10 nm, effective particle diameter based on light scattering method: 6 nm, silane-based surface treatment agent contained) was dispersed such that the weight fraction of zirconium oxide in the total solid components, exclusive of the IPA that is the dispersion medium, was 25 weight %, and mixed together with a photoinitiator.

The 1^{st} order diffraction efficiency of the diffractive optical element 101 of this comparative example was not less than 91% at all of the wavelengths, and the 2^{nd} order diffracted light was 6%.

The diffractive optical element 101 was observed using an optical microscope, and no air bubbles were detected within the effective diameter of the diffractive optical element. Further, the diffractive optical element 101 was cut along a cross section including the optical axis, and the boundary portion between the base 1 and the optical adjustment layer 3 was observed using an optical microscope. Neither variation of the diffraction grating due to interaction of the materials nor a refractive index variation layer was detected. Furthermore, the adhesive property of the optical adjustment layer was examined by the same method as that employed for Inventive Example 1. A peeling off of the layer was detected within the effective diameter of the diffractive optical element.

### Comparative Example 4

As a comparative example, a diffractive optical element which had the same configuration as that of Inventive Example 4 was manufactured by the same method as that employed for Inventive Example 4. The difference from Inventive Example 4 was that the optical adjustment layer was formed of the resin only, without inorganic particles mixed therein.

The diffractive optical element 101 of this comparative example was observed using an optical microscope, and air bubbles were detected within the effective diameter of the diffractive optical element. Further, the diffractive optical element 101 was cut along a cross section including the optical axis, and the boundary portion between the base 1 and the optical adjustment layer 3 was observed using an optical microscope. Neither variation of the diffraction grating due to interaction of the materials nor a refractive index variation layer was detected. Furthermore, the adhesive property of the optical adjustment layer was examined by the same method as that employed for Inventive Example 1. No peeling off of the layer was detected within the effective diameter of the diffractive optical element.

### Comparative Example 5

As a comparative example, a diffractive optical element which had the same configuration as that of Inventive Example 3 was manufactured by the same method as that employed for Inventive Example 3. The difference from Inventive Example 3 was that the optical adjustment layer was formed of the resin only, without inorganic particles mixed therein.

The diffractive optical element 101 of this comparative example was observed using an optical microscope, and air bubbles were detected within the effective diameter of the diffractive optical element. Further, the diffractive optical element 101 was cut along a cross section including the optical axis, and the boundary portion between the base 1 and the optical adjustment layer 3 was observed using an optical microscope. Neither variation of the diffraction grating due to interaction of the materials nor a refractive index variation layer was detected. Furthermore, the adhesive property of the optical adjustment layer was examined by the same method as that employed for Inventive Example 1. No peeling off of the layer was detected within the effective diameter of the diffractive optical element.

### Comparative Example 6

As a comparative example, a diffractive optical element which had the same configuration as that of Inventive Example 5 was manufactured by the same method as that employed for Inventive Example 5. The difference from Inventive Example 5 was that the optical adjustment layer was formed of the resin only, without inorganic particles mixed therein.

The diffractive optical element 101 of this comparative example was observed using an optical microscope, and air bubbles were detected within the effective diameter of the diffractive optical element. Further, the diffractive optical element 101 was cut along a cross section including the optical axis, and the boundary portion between the base 1 and the optical adjustment layer 3 was observed using an optical microscope. Neither variation of the diffraction grating due to interaction of the materials nor a refractive index variation layer was detected. Furthermore, the adhesive property of the optical adjustment layer was examined by the same method as that employed for Inventive Example 1. No peeling off of the layer was detected within the effective diameter of the diffractive optical element.

### 2. Analysis of Results

The composition and the viscosity of the second resin of the diffractive optical elements, ΔSP, ejection, air bubbles, and results of a high temperature/high humidity storage test for the respective inventive examples and comparative examples are shown together in Table 1. Marks in Table 1, ◯, Δ, and x indicate the ejection duration, the state of air bubbles, and the evaluation of the results of the high temperature/high humidity storage test, and indicate the results of respective evaluation items as shown in FIG. 2.

TABLE 1

| | | | | | | High |
|---|---|---|---|---|---|---|
| | | Mixed | | | | Temperature/ |
| | Second | Viscosity | | | | High |
| | Resin | of Second | | | | Humidity |
| | Composition | Resin | | | | Test |
| | Resin A:Resin | (Uncured) | | | | (Adhesive |
| | B:Resin C | (mPa * s) | ΔSP | Ejection | Air Bubbles | Property) |
| Inventive | 5:95:0 | 271 | −0.7 | ◯ | ◯ | ◯ |
| Example 1 | | | | | | |
| Inventive | 20:80:0 | 347 | −0.3 | ◯ | ◯ | ◯ |
| Example 2 | | | | | | |
| Inventive | 40:60:0 | 483 | +0.2 | ◯ | ◯ | ◯ |
| Example 3 | | | | | | |
| Inventive | 50:50:0 | 570 | +0.5 | ◯ | ◯ | ◯ |
| Example 4 | | | | | | |
| Inventive | 60:40:0 | 672 | +0.7 | ◯ | ◯ | ◯ |
| Example 5 | | | | | | |
| Comparative | 0:100:0 | 250 | −0.8 | ◯ | Δ | ◯ |
| Example 1 | | | | | | |
| Comparative | 70:30:0 | 792 | +0.95 | ◯ | ◯ | X |
| Example 2 | | | | | | |
| Comparative | 90:0:10 | 1831 | +1.7 | Δ | ◯ | X |
| Example 3 | | | | | | |
| Comparative | 50:50:0 | 570 | +0.5 | ◯ | X | ◯ |
| Example 4 | | | | | | |
| Comparative | 40:60:0 | 483 | +0.2 | ◯ | X | ◯ |
| Example 5 | | | | | | |
| Comparative | 60:40:0 | 672 | +0.7 | ◯ | X | ◯ |
| Example 6 | | | | | | |

TABLE 2

| | Result | | |
|---|---|---|---|
| | Ejection duration/0.4 μl | Air bubble | High Temp/High |
| | (ejection pressure 0.45 | pressing force | Humidity Test |
| | MPa, temperature 60° | 6.0 kgf, | After storage at |
| | C., needle diameter | Amount of drop | 90° C., humidity |
| | 0.5 mm fixed) | 0.4 μl, fixed | 85%, for 168 hours |
| ◯ | up to 5 min | none | no peeling off |
| | | | detected within |
| | | | effective diameter |
| Δ | 5 min or longer | no bubbles | — |
| | | detected within | |
| | | effective | |
| | | diameter | |
| X | ejection impossible | bubbles detected | peeling off |
| | | within effective | detected |
| | | diameter | |

As seen from Table 1, in Inventive Examples 1 to 5, ΔSP was in the range of not less than −0.7 and not more than +0.7 [cal/cm³]^{1/2}. In Inventive Examples 1 to 5, neither entrapment of air bubbles in formation of the optical adjustment layer nor peeling off of the optical adjustment layer after the high temperature/high humidity test was detected. This is probably because ΔSP was not less than −0.7 and not more than +0.7 [cal/cm³]^{1/2} and both the solubility parameters of the first resin and the second resin were not small so that, in applying the source material 12 of the second optical material onto the diffraction grating of the base 1, air which was present between the base 1 and the source material 12 was purged along the surface of the base 1 or the surface of the source material 12, and entrapment of air bubbles was prevented. Further, it is probably because ΔSP was small so that the adhesive property between the first optical material and the second optical material was improved.

On the other hand, in Comparative Examples 1 to 3, ΔSP was out of the range of not less than −0.7 and not more than +0.7 [cal/cm³]^{1/2}. Therefore, it is inferred that air bubbles were entrapped, and high adhesive property was not obtained, so that the optical adjustment layer was peeled off in the high temperature/high humidity test. Particularly in Comparative Example 1, ΔSp was −0.8, and therefore, the solubility parameter of the second resin contained in the optical adjustment layer 3 was relatively small. Therefore, it is inferred that the wettability of the optical adjustment layer 3 was inferior, and air bubbles were likely to be entrapped. In Comparative Examples 2 and 3, ΔSP was greater than +0.7, and the difference in solubility parameter between the first resin and the second resin was large. Thus, it is inferred that the adhesive property of the first optical material and the second optical material deteriorated, and the optical adjustment layer peeled off in the high temperature/high humidity test.

In Comparative Examples 4 to 6, the second optical material of the optical adjustment layer did not contain inorganic particles. Therefore, it is inferred that the viscosity of the second optical material decreased, and entrapment of air bubbles occurred even when the value of ΔSP was in the range of not less than −0.7 and not more than +0.7 [cal/cm³]^{1/2}.

It is seen from these results that, when the second optical material contains the second resin and inorganic particles and ΔSP is not less than −0.7 and not more than +0.7 [cal/cm³]^{1/2}, a diffractive optical element can be obtained in which entrapment of air bubbles in the diffraction grating would not occur, and the optical adjustment layer would not peel off from the base even in a severe use environment, and which has excellent optical characteristics.

It is also seen that excellent characteristics are achieved when ΔSP is in the range of not less than −0.7 and not more than +0.7 [cal/cm³]^{1/2}, and this is a distinctive feature of the composite material.

### INDUSTRIAL APPLICABILITY

A diffractive optical element disclosed in the present application can be suitably used as, for example, a lens of a camera, a spatial low pass filter, a polarization hologram element, etc. Particularly, the diffractive optical element of the present embodiment is suitably used as an optical element for devices which are to be installed in a place where the environmental temperature variation or vibration is large.

### REFERENCE SIGNS LIST

1 base
2 diffraction grating
3 optical adjustment layer
4 inorganic particles
5 matrix resin
10 flask
11 dispenser
12 source material of optical adjustment layer containing no solvent
12′ source material of optical adjustment layer containing solvent
13 die
101 diffractive optical element

1. A diffractive optical element, comprising:
a base which is made of a first optical material containing a first resin and which has a diffraction grating in its surface; and
an optical adjustment layer which is made of a second optical material containing a second resin and inorganic particles and which is provided on the base so as to cover the diffraction grating,
wherein ΔSP which is defined by a formula shown below is not less than −0.7 and not more than +0.7 [cal/cm³]^{1/2}:
ΔSP=[a solubility parameter of the second resin]−[a solubility parameter of the first resin], and
a design order of diffraction caused by the diffraction grating is n^{th} order, and unwanted order diffracted light of n+1^{th} order in a wavelength range of not less than 400 nm and not more than 700 nm is not more than 7%.

2. A diffractive optical element, comprising:
a base which is made of a first optical material containing a first resin and which has a diffraction grating in its surface; and
an optical adjustment layer which is made of a second optical material containing a second resin and inorganic particles and which is provided on the base so as to cover the diffraction grating,
wherein ΔSP which is defined by a formula shown below is not less than −0.7 and not more than +0.7 [cal/cm³]^{1/2}:
ΔSP=[a solubility parameter of the second resin]−[a solubility parameter of the first resin], and
the diffractive optical element does not include, in part of the base on the optical adjustment layer side and part of the optical adjustment layer on the base side, a portion whose refractive index is different from both of refractive indices of the first optical material and the second optical material.

3. The diffractive optical element of claim 1, wherein ΔSP is not less than +0.5 and not more than +0.7 [cal/cm³]^{1/2}.

4. The diffractive optical element of claim 1, wherein the first resin contains at least one of polycarbonate and a resin which has a fluorene structure.

5. The diffractive optical element of claim 1, wherein the second resin contains pentaerythritol triacrylate.

6. The diffractive optical element of claim 1, wherein the inorganic particles contain, as a major constituent, at least one selected from the group consisting of zirconium oxide, yttrium oxide, lanthanum oxide, hafnium oxide, scandium oxide, alumina, and silica.

7. The diffractive optical element of claim 1, wherein the refractive index of the first optical material is smaller than the refractive index of the second optical material, and a wavelength dispersibility of the refractive index of the first optical material is greater than a wavelength dispersibility of the refractive index of the second optical material.

8. The diffractive optical element of claim 6, wherein an effective particle diameter of the inorganic particles is not less than 1 nm and not more than 100 nm.

9. A method for manufacturing a diffractive optical element, comprising the steps of:
providing a base which is made of a first optical material containing a first resin and which has a diffraction grating in its surface;
providing a source material of a second optical material which contains inorganic particles and a source material of a second resin;
placing the source material of the second optical material on the base so as to cover the diffraction grating; and
curing the source material of the second resin with a die which defines a contour of an optical adjustment layer being pressed against the source material of the second optical material, thereby forming the optical adjustment layer which is made of the second optical material containing the second resin and the inorganic particles,
wherein the source material of the second optical material contains substantially no solvent before the step of placing the source material of the second optical material, and
ΔSP which is defined by a formula shown below is not less than −0.7 and not more than +0.7 [cal/cm³]^{1/2}:
ΔSP=[a solubility parameter of the second resin]−[a solubility parameter of the first resin].

10. The method of claim 9, wherein the step of providing the source material of the second optical material includes the steps of
mixing together the inorganic particles dispersed in a solvent and the source material of the second resin, thereby obtaining a mixture, and
removing the solvent from the mixture.

11. The method of claim 9, wherein a viscosity of the source material of the second optical material which is in an uncured state is not more than 1000 mPa·s.

12. The method of claim 9, wherein the first resin contains at least one of polycarbonate and a resin which has a fluorene structure.

13. The method of claim 9, wherein the second resin contains pentaerythritol triacrylate.

14. The diffractive optical element of claim 2, wherein ΔSP is not less than +0.5 and not more than +0.7 [cal/cm³]^{1/2}.

15. The diffractive optical element of claim 2, wherein the first resin contains at least one of polycarbonate and a resin which has a fluorene structure.

16. The diffractive optical element of claim 2, wherein the second resin contains pentaerythritol triacrylate.

17. The diffractive optical element of claim 2, wherein the inorganic particles contain, as a major constituent, at least one selected from the group consisting of zirconium oxide, yttrium oxide, lanthanum oxide, hafnium oxide, scandium oxide, alumina, and silica.

18. The diffractive optical element of claim 2, wherein the refractive index of the first optical material is smaller than the refractive index of the second optical material, and a wavelength dispersibility of the refractive index of the first optical material is greater than a wavelength dispersibility of the refractive index of the second optical material.

19. The diffractive optical element of claim 17, wherein an effective particle diameter of the inorganic particles is not less than 1 nm and not more than 100 nm.
